(19) United States
(12) Patent Application Publication
(10) Pub. No.: US 2008/0001317 A1
(43) Pub. Date: Jan. 3, 2008

(54) WATER SOLUBLE BIOMEDICAL DEVICE MOLD

(76) Inventors: Jason Tokarski, Jacksonville, FL (US); Kevin P. McCabe, St. Augustine, FL (US); Vincent H. Barre, Jacksonville, FL (US); Changhong Yin, St. Augustine, FL (US); Thomas Wilkinson, Jacksonville, FL (US); Robert J. Watterson, Jacksonville, FL (US); Jeffery S. Longo, Jacksonville, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/427,089

(22) Filed: Jun. 28, 2006

(51) Int. Cl. B29D 11/00; B29C 33/40; B29C 33/76

(52) U.S. Cl. 264/1.32; 249/61; 249/62; 249/134; 249/63; 264/2.5; 264/2.6; 264/219; 264/221; 264/317; 264/328.8

(57) ABSTRACT

The present invention includes methods and appartus for forming a biomedical device, such as an ophthalmic lens, wherein the biomedical device is formed with a mold part which is water soluble.

### FIELD OF THE INVENTION

This invention relates to molds for forming a biomedical device, such as an ophthalmic lens. More specifically, the present invention relates to apparatus and methods for fashioning biomedical devices with a mold that includes At least a portion of the mold which is water soluble.

### BACKGROUND OF THE INVENTION

It is well known that contact lenses can be used to improve vision. Various contact lenses have been commercially produced for many years. Early designs of contact lenses were fashioned from hard materials. Although these lenses are still currently used in some applications, they are not suitable for all patients due to their poor comfort and relatively low permeability to oxygen. Later developments in the field gave rise to soft contact lenses, based upon hydrogels.

Hydrogel contact lenses are very popular today. These lenses are often more comfortable to wear than contact lenses made of hard materials. Malleable soft contact lenses can be manufactured by forming a lens in a multi-part mold where the combined parts form a topography consistent with the desired final lens.

During typical ophthalmic lens manufacturing processes, Front Curve (FC) and Back Curve (BC) molds are injection molded. A reaction mixture comprising a monomer or prepolymer is dosed into the FC mold. The BC mold is deposited on top of the FC to enclose the reaction mixture into a cavity with the appropriate lens geometry. This assembly is exposed to light, which allows the monomer to polymerize or cure, to create the ophthalmic lens. After the lens is cured, a demold process is used to mechanically pry the BC mold away from the lens and FC mold. Finally, the lens and FC are submersed in fluid and the lens releases from the FC mold.

Following cure, traditional practice dictates that the mold portions are separated and the lens remains adhered to one of the mold portions. A release process detaches the lens from the remaining mold part. However, the release process is often difficult since the adhesion to the mold part is significant as compared to the physical properties of the cured lens. The demold process has historically been one of the largest contributor to edge defects on the contact lens due to the mechanical stresses applied to the lens during the pry process. Release process steps can be time consuming, which detracts from manufacturing line objectives. In addition, stresses incurred by the lens during release can result in damage to the lens, such as chips and tears. In another aspect, release of silicone lens materials may include exposing the lens to an organic solvent, such as isopropyl alcohol (hereinafter, “IPA”). Since IPA is flammable, handling IPA in a production environment requires additional safety measures be undertaken and appropriate disposal. All of which add cost and complexity to the process.

Therefore, it would be advantageous to provide apparatus and methods which facilitate the use of a mold part with a water soluble portion which can thereby facilitate or completely eliminate the need for release the lens from the mold part.

### SUMMARY OF THE INVENTION

Accordingly, the present invention provides mold parts for forming biomedical devices, such as ophthalmic lenses, wherein at least a portion of the mold parts is formed form a water soluble material, such as modified polyvinyl alcohol and apparatus, systems and methods for producing the mold parts with water soluble portions.

Previously known lens release methods are sometimes ineffective because they rely on external influences to overcome the adhesive force between the surface of the contact lens and the concave casting cup. Instead of trying to overcome the aforementioned adhesive force, a concave casting cup composed of modified PVOH is completely dissolved in water, leaving the contact lens.

### DESCRIPTION OF THE DRAWINGS

FIG. 1 illustrates a diagram of an ophthalmic lens mold.

FIG. 2 illustrates method steps that can be implemented while practicing the present invention.

FIG. 2a illustrates additional method steps that can be implemented while practicing the present invention

FIG. 3 illustrates apparatus stations that can be used to implement some embodiments of the present invention.

FIG. 4 illustrates a cross section of an ophthalmic lens mold with a surface layer and a core layer.

FIG. 5 includes a chart illustrating the dissolution time of mold material versus the temperature of an aqueous solution such as deionized water.

FIG. 6 includes a chart illustrating the dissolution rate of mold material versus the temperature and agitation rate of an aqueous solution, such as deionized water.

FIG. 7 includes a chart illustrating average light transmission of a old material versus wavelength.

FIG. 8 includes a chart illustrating storage modulus of a mold material versus temperature.

FIG. 9 includes a chart illustrating loss tangent of a mold material versus temperature.

FIG. 10 illustrates a cross section depicting a mold material comprising a blend of water soluble and non-water soluble materials.

### DETAILED DESCRIPTION OF THE INVENTION

Generally, the present invention is directed to a mold part for forming a biomedical device, wherein at least a portion of the mold part is water soluble. The mold part can therefore include, for example, a casting cup for forming an ophthalmic lens. According to the present invention, the water soluble portion of the mold part comprises a modified polymer, such as modified polyvinyl alcohol polymer. Following formation of a biomedical device utilizing the mold part with the water soluble portion, the mold part may be exposed to water to dissolve the water soluble portion and thereby facilitate removal of the lens from the mold.

As used herein, polyvinyl alcohol (also sometimes referred to as PVOH, PVA, and PVAL) is a biodegradable polymer that decomposes when exposed to H₂O. The decomposition products include H₂O and CO₂. The basic polymer structure of PVOH includes:

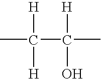

Previous to the present invention, the use of PVOH as a casting cup material for ophthalmic lens processing has been limited due to the thermal properties of PVOH. Specifically, the traditional melt processing temperature and thermal degradation temperature of pure PVOH are almost the same. Therefore, it is very difficult to process pure PVOH with typical thermoplastic processing methods, i.e. injection molding, without degrading the polymer. According to the present invention, PVOH is modified to provide a lower melt processing temperatures, whereby the PVOH can be used in injection molding without significantly degrading its physical properties.

As used here, the term “mold” refers to a rigid or semi-rigid object that may be used to form lenses from uncured formulations. The preferred molds are two part molds as described above, where either the front curve or the back curve of the mold is at least partially formed from a modified water soluble PVOH. Examples of modified water soluble PVOH include but are not limited to Aqua-Sol 1220.

As used herein, “released from a mold,” means that a lens is either completely separated from the mold, or is only loosely attached so that it can be removed with mild agitation or pushed off with a swab.

### Lenses

As used herein “lens” refers to any ophthalmic device that resides in or on the eye. These devices can provide optical correction or may be cosmetic. For example, the term lens can refer to a contact lens, intraocular lens, overlay lens, ocular insert, optical insert or other similar device through which vision is corrected or modified, or through which eye physiology is cosmetically enhanced (e.g. iris color) without impeding vision. In some embodiments, the preferred lenses of the invention are soft contact lenses are made from silicone elastomers or hydrogels, which include but are not limited to silicone hydrogels, and fluorohydrogels.

As used herein, the term “lens forming mixture” refers to a monomer or prepolymer material which can be cured, to form an ophthalmic lens. Various embodiments can include lens forming mixtures with one or more additives such as: UV blockers, tints, photoinitiators or catalysts, and other additives one might desire in an ophthalmic lenses such as, contact or intraocular lenses. Lens forming mixtures are more fully described below.

### Molds

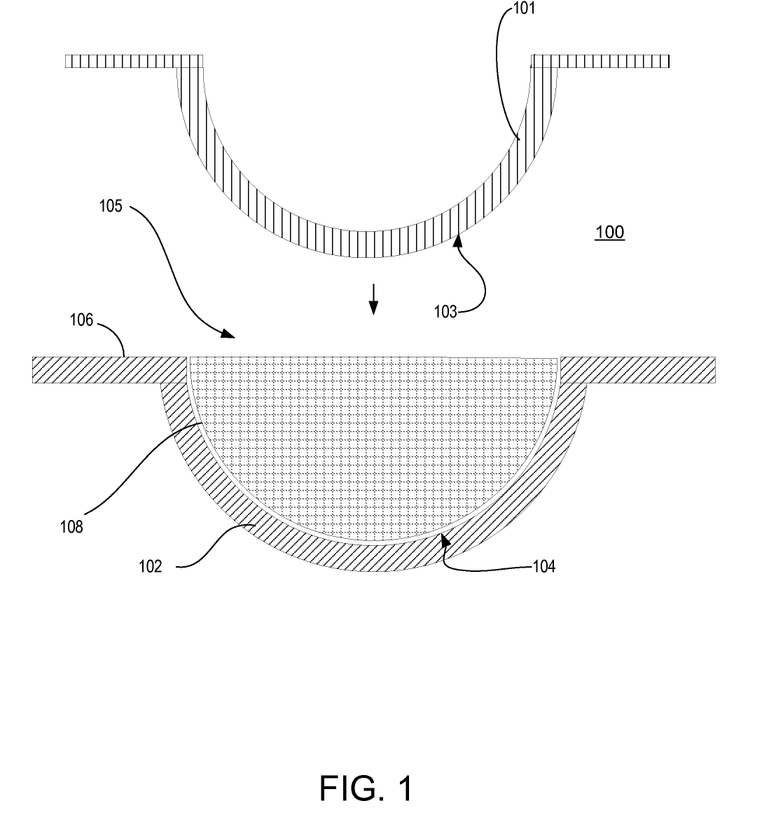

Referring now to FIG. 1, a diagram of an exemplary mold for an ophthalmic lens is illustrated. As used herein, the terms “mold” and “mold assembly” refer to a form 100 having a cavity 105 into which a lens forming mixture can be dispensed such that upon reaction or cure of the lens forming mixture, an ophthalmic lens 108 of a desired shape is produced. The molds and mold assemblies 100 of this invention are made up of more than one “mold parts” or “mold pieces” 101-102. The mold parts 101-102 can be brought together such that a cavity 105 is formed by combination of the mold parts 101-102 and a lens 108 can be fashioned in the cavity 105. This combination of mold parts 101-102 is preferably temporary. Upon formation of the lens, the mold parts 101-102 can again be separated for removal of a fashioned lens (not shown.

A “mold part” as the term is used in this specification therefore refers to a portion of mold 101-102, which when combined with another portion of a mold 101-102 forms a mold 100 (also referred to as a mold assembly 100). At least one mold part 101-102 is designed to have at least a portion of its surface 103-104 in contact with the lens forming mixture such that upon reaction or cure of the lens forming mixture that surface 103-104 provides a desired shape and form to the portion of the lens with which it is in contact. The same is true of at least one other mold part 101-102.

Thus, for example, in a preferred embodiment a mold assembly 100 is formed from two parts 101-102, a female concave piece (front curve mold part) 102 and a male convex piece (back curve mold part) 101 with a cavity 105 formed therebetween. The portion of the concave surface 104 which makes contact with reaction mixture (sometimes referred to as “lens forming mixture”) has the curvature of the front curve of an ophthalmic lens 108 to be produced in the mold assembly 100 and is sufficiently smooth and formed such that the surface of a ophthalmic lens 108 formed by polymerization of the reaction mixture which is in contact with the concave surface 104 is optically acceptable.

The back curve mold part 101 has a convex surface 103 in contact which contacts the lens forming mixture and has the curvature of the back curve of a ophthalmic lens to be produced in the mold assembly 100. The convex surface 103 is sufficiently smooth and formed such that the surface of a ophthalmic lens formed by reaction or cure of the lens forming mixture in contact with the back surface 103 is optically acceptable. Accordingly, any such surface 103-104 can have an optical quality surface finish, which indicates that it is sufficiently smooth and formed so that a lens surface fashioned by the polymerization of a lens forming material in contact with the molding surface is optically acceptable. Further, in some embodiments, the lens forming surface 103-104 can have a geometry that is necessary to impart to the lens surface the desired optical characteristics, including without limitation, spherical, aspherical and cylinder power, wave front aberration correction, corneal topography correction and the like as well as any combinations thereof. Generally, the inner concave surface 104 of the front curve mold part 102 defines the outer surface of the ophthalmic lens 108, while the outer convex surface 103 of the back mold piece 101 defines the inner surface of the ophthalmic lens 108.

Typically lenses are formed on at least one surface of both mold parts. However, in some embodiments, one surface of the lenses may be formed from a mold and the other surface could be formed using a lathing method, or other methods.

Aside from the water soluble polymers, in some embodiments, the molds of the invention may contain additives that facilitate the separation of the lens forming surfaces, reduce the adhesion of the cured lens to the molding surface, or both. For example, additives such as metal or ammonium salts of stearic acid, amide waxes, polyethylene or polypropylene waxes, organic phosphate esters, glycerol esters or alcohol esters may be added to the material used to form the mold parts 101-102 prior to forming the mold.

Examples of additives which may be added to the mold part material may include, but are not limited to: Dow Siloxane MB50-321 and Dow Siloxane MB50-321 (a silicone dispersion), Nurcrel 535 & 932 (ethylene-methacrylic acid co-polymer resin Registry No. 25053-53-6), Erucamide (fatty acid amide Registry No. 112-84-5), Oleamide (fatty acid amide Registry No. 301-02-0), Mica (Registry No. 12001-26-2), Atmer 163 (fatty alkyl diethanolamine Registry No.107043-84-5), Pluronic (polyoxypropylene-polyoxyethylene block co-polymer Registry No.106392-12-5), Tetronic (alkyoxylated amine 110617-70-4), Flura (Registry No.7681-49-4), calcium stearate, zinc stearate, Super-Floss anti block (slip/anti blocking agent, Registry No. 61790-53-2), Zeospheres anti-block (slip/anti blocking agent); Ampacet 40604 (fatty acid amide), Kemamide (fatty acid amide), Licowax fatty acid amide, Hypermer B246SF, XNAP, polyethylene glycol monolaurate (anti-stat) epoxidized soy bean oil, talc (hydrated Magnsium silicate), calcium carbonate, behenic acid, pentaerythritol tetrastearate, succinic acid, epolene E43-Wax, methyl cellulose, cocamide (anti-blocking agent Registry No. 61789-19-3), poly vinyl pyrrolidinone (360,000 MW).

Still further, in addition to the water soluble polymer, the molds of the invention may contain other polymers such as polypropylene, polyethylene, polystyrene, polymethyl methacrylate, and modified polyolefins. For example, a blend of the water soluble polymer and polypropylene (Zieglar Natta or metallocene catalyst process with nucleation, where ATOFINA EOD 00-11) may be used, where the ratio by weight percentage of water soluble polymer to polypropylene ranges from about 99:1, to about 10:90 respectively. Such blends can be used on either or both mold parts 101-102. In some embodiments, it is preferred that such blend is used on the back curve and the front curve consists of a cyclic olefin.

As used herein, the term “uncured” refers to the physical state of a reaction mixture (sometimes referred to as “lens formulation”) prior to final curing to form a lens 108. Some lens formulations contain mixtures of monomers which are cured only once. Other lens formulations contain monomers, partially cured monomers, macromers, prepolymers and other components.

According to the present invention, following final curing of the lens 108 or other biomedical device, one or more of the mold parts 101-102 may be exposed to water, such as deionized (hereinafter, “DI”) water. Exposure to the water can be operative to dissolve the water soluble portion and thereby facilitate release of the lens 108 from the mold part 101-102. In some embodiments, the mold part 101-102 can be essentially entirely formed of water soluble material, such as modified PVOH.

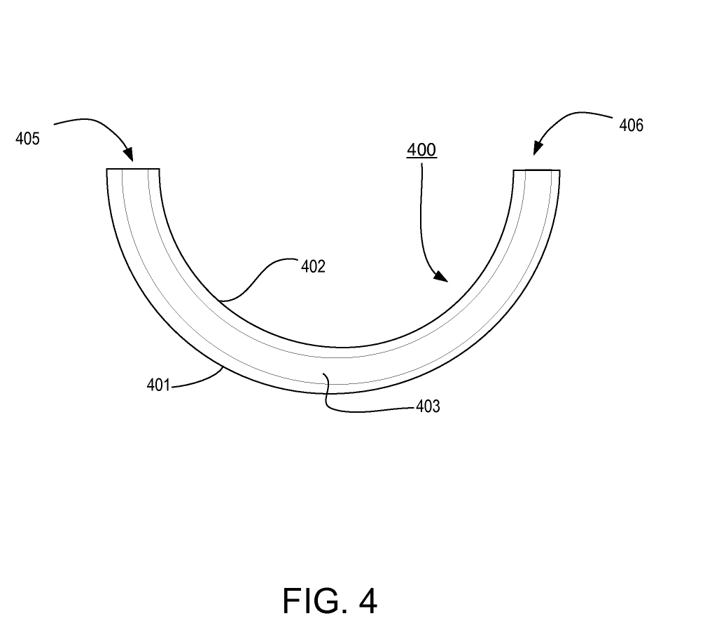

In other embodiments, the water soluble material can be intermixed with a non-water soluble material such that after the water soluble material is dissolved, the non water soluble material remaining forms a porous surface. In still other embodiments, a multilayer mold can be formed that provides core stability from a non water soluble material, such as, for example, a cyclic olefin (hereinafter “core layer”) and a surface layer from a water soluble material, such as modified PVOH (hereinafter “surface layer”). After dissolution of the PVOH, the lens 108 will no longer be adhered to the core layer (discussed further below with reference to FIG. 4).

### Method Steps

Further this invention includes a method of making an ophthalmic lens with steps that include dispensing an uncured lens reaction mixture into a mold comprising, consisting essentially of, or consisting of, a water soluble polymer. In some embodiments, the water soluble polymer can include modified PVOH, such as, for example, Aqua-Sol 1220.

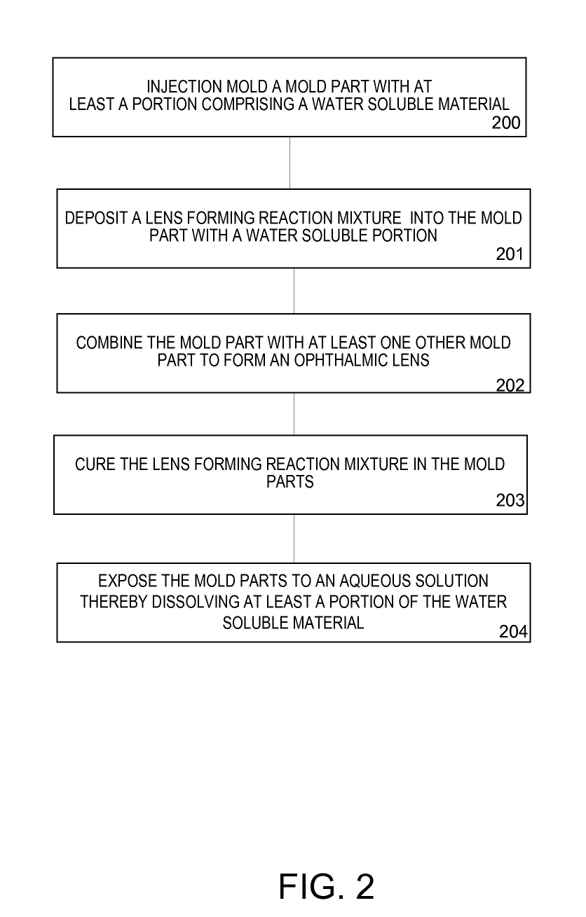

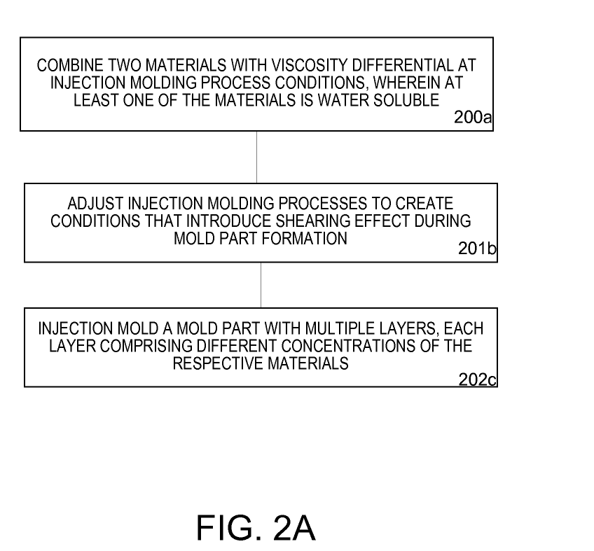

Referring now to FIG. 2, a flow diagram illustrates exemplary steps that may be implemented in some embodiments of the present invention. It is to be understood that some or all of the following steps may be implemented in various embodiments of the present invention.

At 200, injection molding processes are used to form one or more mold parts 101-102 wherein at least a portion of at least one mold part 101-102 utilized to form a biomedical device, such as for example, an ophthalmic lens 108 injection molded from material which is water soluble. In some preferred embodiments, at least one mold part is formed essentially entirely of a material which is water soluble. Exemplary water soluble materials, include modified PVOH, and in particular a material with the physical characteristics of Aqua-Sol 1220.

At 201, the Reaction Mixture is deposited into a first mold part 102, which is utilized to shape the ophthalmic lens 108.

At 202, the first mold part 102 can be combined with at least one other mold part 101-102 to shape the deposited Reaction Mixture into the desired shape of a biomedical device, such as an ophthalmic lens 108.

At 203, the Reaction Mixture is cured and formed into a lens 108. Curing can be accomplished, for example, by various means known in the art, such as, for example, exposure of the reaction mixture to actinic radiation, exposure of the reaction mixture to elevated heat (i.e. 40° C. to 75° C.), or exposure to both actinic radiation and elevated heat.

At 204, the mold parts 101-102 can be exposed to a hydration solution. The hydration solution can include, for example, deionized (DI) water or an aqueous solution. The mold parts 101-102 can be exposed to the aqueous solution for a time period sufficient to dissolve the water soluble portions of the mold parts, which, in some embodiments will include one or more entire mold parts.

A historical contributor to yield has been the effectiveness of a formed lens to release from the respective mold parts 101-102 during demold. In previously known methods, the ophthalmic lens 108, which is adhered to a mold part 101-102 is put into a fluid at a specified temperature. The relative expansion or shrinkage of the two materials in the fluid enables the lens to release from the mold part 101-102. However, this method is not entirely effective and can be time consuming, which results in a decrease in overall yield.

Dissolution of one or more mold part 101-102 can eliminate the demold traditionally used to mechanically separate the mold parts 101-102. Elimination of demold can also result in improved lens edge quality by eliminating the mechanical stresses associated therewith. Benefits of the present invention therefore include a simplified process sans demold process and apparatus, as well as increased yield and improved lens edge quality.

In some embodiments an aqueous solution can include one or more additives, such PEG; PEO; Tween 80, which is polyoxyethylene sorbitan monooleate; Tyloxapol; octylphenoxy (oxyethylene) ethanol; amphoteric 10); preservatives (e.g. EDTA, sorbic acid, DYMED, chlorhexadine gluconate; hydrogen peroxide; thimerosal; polyquad; polyhexamethylene biguanide; antibacterial agents; lubricants; salts and buffers. In some embodiments, additives can be added to the hydration solution in amounts varying between 0.01% and 10% by weight, but cumulatively less than about 10% by weight.

The temperatures of the hydration solution can be anywhere from near freezing to near boiling; however, it is preferred that the temperatures between 60° C. and 95° C.

Exposure of the one or more mold parts 101-102 to the hydration solution can be accomplished by washing, spraying, soaking, submerging, or any combination of the aforementioned.

According to some embodiments of the present invention that expose the lenses to the hydration solution via submersion, magazines can be accumulated and then lowered into tanks containing the hydration solution. In addition, in some embodiments, the hydration solution can be heated to a temperature of between about 60° C. and 95° C.

Referring to FIG. 2A, in some embodiments, a multilayer mold part can be formed by combining at least two materials with a viscosity differential at the injection molding process conditions used to form the mold part, wherein at least one of the material is water soluble. The two materials can be miscible or miscible at a microscopic level. At 200b, injection molding conditions that can be varied to facilitate the viscosity differential can include, for example: the temperature of the injected materials; the speed of injection of the materials; the pressure under which the materials are injected; the geometry of a hotrunner used in the injection molding process, the size of a gate used in the injection molding process, and other injection molding variables. At 200c, the mold part can be injection molded. Mold parts formed according to these embodiments may only have surface layer portion of the mold part 1010-102 which is water soluble, as discussed more fully below.

### Apparatus

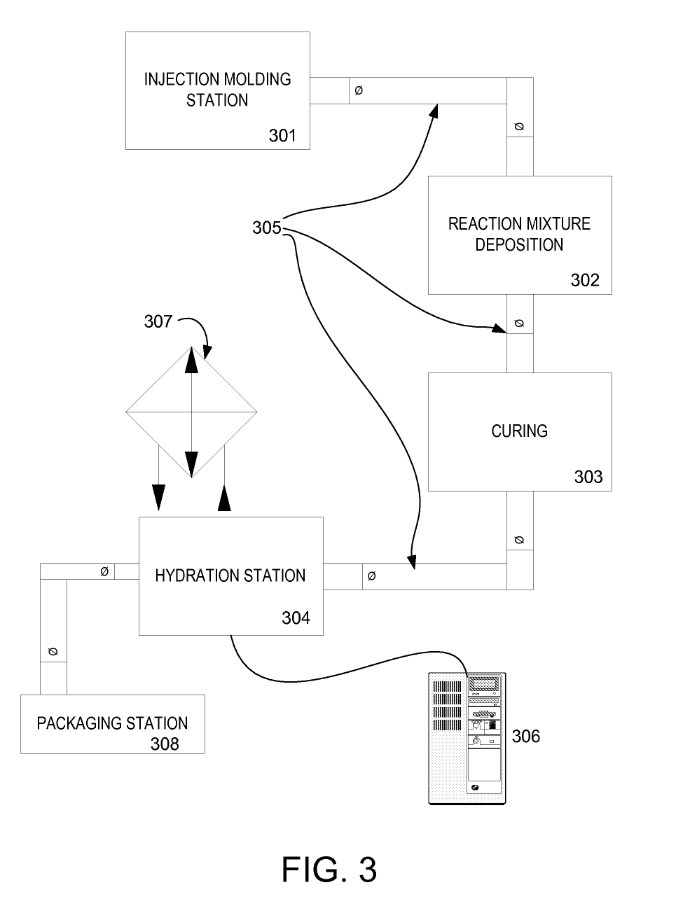

Referring now to FIG. 3, a block diagram is illustrated of apparatus contained in processing stations 301-304 that can be utilized in implementations of the present invention. In some preferred embodiments, processing stations 301-304 can be accessible to ophthalmic lenses 100 via a transport mechanism 305. The transport mechanism 305 can include for example one or more of: a robot, a conveyor and a rail system in conjunction with a locomotion means that may include, a conveyor belt, chain, cable or hydraulic mechanism powered by a variable speed motor or other known drive mechanism (not shown).

Some embodiments can include back surface mold parts 101 placed in pallets (not shown). The pallets can be moved by the transport mechanism 305 between two or more processing stations 301-304. A computer or other controller 306 can be operatively connected to the processing stations 301-304 to monitor and control processes at each station 301-304 and also monitor and control the transport mechanism 305 to coordinate the movement of lenses between the process stations 301-304.

Processing stations 301-304 can include, for example, an injection molding station 301. At the injection molding station 301, injection molding apparatus forms mold parts 101-102 suitable for manufacturing a desired biomedical device, such as the ophthalmic lens 108.

Processing station 302 can include a deposition station which deposits a quantity of a Reaction Mixture into the front curve mold portion 102 and preferably completely cover the mold surface 104 with the Reaction Mixture. The Reaction Mixture should comprise any material or mixture of materials, which upon polymerization yields an optically clear, integral shape-sustaining contact lens or contact lens precursor, such as, for example, a silicone hydrogel monomer or prepolymer.

A curing station 303 can include apparatus for polymerizing the Reaction Mixture. Polymerization is preferably carried out by exposing the Reaction Mixture to a source of initiation which can include for example, one or more of: actinic radiation and heat. Curing station 302 therefore includes apparatus that provide a source of initiation of the Reaction Mixture deposited into the front curve mold 102. In some embodiments, actinic radiation can be sourced from bulbs under which the mold assemblies travel. The bulbs can provide an intensity of actinic radiation in a given plane parallel to the axis of the bulb that is sufficient to initiate polymerization.

In some embodiments, a curing station 303 heat source can be effective to raise the temperature of the Reactive Mixture to a temperature sufficient to assist the propagation of the polymerization and to counteract the tendency of the Reaction Mixture to shrink during the period that it is exposed to the actinic radiation and thereby promote improved polymerization. Some embodiments can therefore include a heat source that can maintain the temperature of the Reaction Mixture (by which is meant that resin before it begins to polymerize, and as it is polymerizing) above the glass transition temperature of the polymerized product or above its softening temperature as it is polymerizing. Such temperature can vary with the identity and amount of the components in the Reaction Mixture. In general, some embodiments include apparatus capable of establishing and maintaining temperatures on the order of 40° C. degree to 75° C.

In some embodiments, a source of heat can include a duct, which blows warm gas, such as, for example, N₂ or air, across and around the mold assembly as it passes under the actinic radiation bulbs. The end of the duct can be fitted with a plurality of holes through which warm gas passes. Distributing the gas in this way helps achieve uniformity of temperature throughout the area under the housing. Uniform temperatures throughout the regions around the mold assemblies can facilitate more uniform polymerization.

In some embodiments, polymerization of Reaction Mixture can be carried out in an atmosphere with controlled exposure to oxygen, including, in some embodiments, an oxygen-free environment, because oxygen can enter into side reactions which may affect a desired optical quality, as well as the clarity of the polymerized lens. In some embodiments, the lens mold halves are also prepared in an atmosphere that has limited oxygen or is oxygen-free. Methods and apparatus for controlling exposure to oxygen are well known in the art.

The hydration station 304 can be used to expose the mold parts and newly formed lens to an aqueous solution. According to the present invention, the aqueous solution will dissolve at least a portion of the mold part 101-102. Some alternate embodiments can also include a demold station (not shown) to demold the mold parts 101-102 of those embodiments with a mold part with only some material which is water soluble.

In some embodiments, a cured lens which includes a polymer/diluent mixture can also be treated by exposure to a hydration solution at a hydration station 304 to remove diluent from the lens 108 and ultimately replace the diluent with water, such as a silicone hydrogel ophthalmic lens formed having a final size and shape which are quite similar to the size and shape of the original molded polymer/diluent article.

In some embodiments, a heat exchanger 307 is used to maintain the temperature of the hydration solution at a temperature greater than typical ambient room temperature. For example, and without limitation, a heat exchanger can be used to raise the temperature of the hydration solution to about 60° C. to about 95° C.

### Lens Materials

As used herein “lens” refers to any ophthalmic device that resides in or on the eye. These devices can provide optical correction or may be cosmetic. The term lens includes but is not limited to soft contact lenses, intraocular lenses, overlay lenses, ocular inserts, and optical inserts. In some embodiments, preferred lenses of the invention are soft contact lenses are made from silicone elastomers or hydrogels, which include but are not limited to silicone hydrogels, and fluorohydrogels. Soft contact lens formulations are disclosed in U.S. Pat. No. 5,710,302, EP 406161, JP 2000016905, U.S. Pat. No. 5,998,498, U.S. Pat. No. 6,087,415, U.S. Pat. No. 5,760,100, U.S. Pat. No. 5,776,999, U.S. Pat. No. 5,789,461, U.S. Pat. No. 5,849,811, and U.S. Pat. No. 5,965,631. Further polymers that may be used to form soft contact lenses are disclosed in the following U.S. Pat. Nos. 6,419,858; and 6,416,690.

Other preferred embodiments of the resent invention can include lenses of etafilcon A, genfilcon A, lenefilcon A, polymacon, acquafilcon A, balafilcon A, lotrafilcon A, galyfilcon A, senofilcon A, silicone hydrogels, including for example, lenses described in U.S. Pat. No. 6,087,415, U.S. Pat. No. 5,760,100, U.S. Pat. No. 5,776,999, U.S. Pat. No. 5,789,461, U.S. Pat. No. 5,849,811, and U.S. Pat. No. 5,965,631. Other embodiments can include ophthalmic lenses made from prepolymers. These patents as well as all other patent disclosed in this application are hereby incorporated by reference in their entirety.

### Injection Molding

Referring now to FIG. 4, according to some embodiments of the present invention, mold part 101-102 with a surface layer and core layer mold is injection molded with a single unit injection molding apparatus by blending or compounding plastic resins with different viscosities under conditions present during injection molding conditions used to form the mold part. The blending or compounding methods can include, for example: simple hand/machine blending; single screw compounding, twin screw compounding; or multiple screw compounding. Other embodiments can include apparatus that utilizes two or more injection molding units to inject two or more materials into the mold cavity.

A mold part 400 is injected molded from a compound resin that includes at least a first material and a second material, wherein at least one of the materials is water soluble, such as, for example, modified PVOH. Other materials can include, for example, a cyclic olefin. Injection molding of the mold part 400 can be accomplished by introducing melted compound resin into a mold cavity designed to fashion the mold part 400 at a proximate end 405 and pushing the melted compound resin through the mold cavity until it flows to a distal end 406 of the mold part 400.

As the melted compound resin is pushed through the mold cavity, a first material will separate out to the surface of the mold part 400 and a second material will separate out to the core of the mold part 400.

In some embodiments, the material with a lower melt viscosity will tend to flow to the surface 401-402 of the mold part 400 and the higher melt viscosity material will tend to remain in the core 403 of the mold part 400. Generally, the separation will not be complete, however, at any given cross section the material with the higher melt flow rate will be at a higher concentration in a surface layer 401-402 as compared with the core layer 403. Similarly, the lower melt viscosity material will separate into the core layer 403 such that at any given cross section, the amount of the low melt viscosity material in the core layer 403 will be greater than the amount of the low melt flow material in the surface layer 401-402. In some embodiments, the first material and the second material can include two same type resins but the first material and the second material can have different melt viscosities at the conditions present in the injection molding process used to form the mold part 400.

Various embodiments can also include a first mold material with a lower surface energy that separates out into a surface layer 401-402 and a second material, with a relatively higher surface energy, which separates out into the core layer 403. Conversely, it is within the scope of this invention to include a first material with a higher surface energy than a second material. In another aspect, a first material can have a higher modulus or a lower modulus than a second material.

Preferred embodiments can include, a mold part with a surface layer 410-402 of water soluble material. Following cure of the Reaction Mixture, the water soluble material may be dissolved which will detach the formed lens 108 from the mold part 101-102. Specific examples of material that can be used to practice the present invention can include: Aqua-Sol 1220 as a water soluble modified PVOH and non-water soluble materials, such as Zeonor 1060R® and polypropylene, such as ExxonMobil® PP1654 or PP9544; polystyrene and polypropylene, Zeonor 1060R® and polyvinyl alcohol; polystyrene and polyvinyl alcohol; and other combinations of different material or same type resins with differentials in melt viscosity.

It is also within the scope of the invention to include an additive such as siloxane (for example Dow Corning MB50-001 comprising essentially 50% polypropylene and 50% siloxane) in an amount of about 5% into a blend of polymers facilitate a majority of a material separating into the surface layer 401-402. Therefore, it is within the scope of the present invention to include additives, such as siloxane containing materials in the combined materials used to form a mold part. For example in some preferred embodiments a material including up to about 10% siloxane can the mold material. Other additives are also within the scope of the invention.

Accordingly, it is within the scope of some embodiments of the present invention to for the modified PVOH to comprise only used a convex casting cup, wherein a mold assembly can be submersed in water to allow the convex cup to dissolve. After the convex cup is dissolved, the lens can be released from the concave cup (composed of a non-PVOH material) via any known method of lens release. A benefit of a convex mold part only includes improved contact lens quality through the elimination of edge defects caused by the physical demolding of the convex cup from the lens assembly. Additionally, the lens fabrication process is simplified by the elimination of the demold process step.

In other embodiments, the modified PVOH can comprise only the concave casting cup, the convex cup is demolded from the mold assembly using any method of demold (i.e. pry). The lens and concave cup are then submersed in water to allow the concave cup to dissolve. The advantage of this includes improved lens release from the concave cup.

Some embodiments can also include the use of modified PVOH in both the convex and concave casting cups. In such applications, the benefits associated with the use of the modified PVOH as both the convex and concave casting cups are achieved.

According to the present invention, in addition to the use of a material, such as a modified PVOH can also provide other benefits previously unobtainable in a mold part for an ophthalmic lens. The benefits can include, for example, melt processable water soluble material below degradation temperature; enhanced hydrophilic qualities; and controllable dissolution rate.

As discussed above, the use of PVOH as a casting cup material in ophthalmic lens manufacturing has previously been limited due to its thermal degradation properties.

According to embodiments of the present invention, thermal degradation issues can be addressed via the use of a modified PVOH to allow for the material to be melt-processed at temperatures below the thermal degradation temperature. An example of a modified PVOH may include compounding the material with plasticizers to reduce the melt processing temperature. The modified PVOH polymers that are currently being evaluated are commercially available and are supplied by A. Schulman, Inc. under the trade name “Aqua-Sol”.

As an example, Table 1 shows a Thermogravimetric Analysis (TGA) of Aqua-Sol 1220. In this graph, the weight of the polymer sample is plotted as a function of temperature. Weight loss of the polymer sample at increased temperature is one manifestation of thermal degradation. In the case of the Aqua-Sol 1220, moderate weight loss occurs up to approximately 250° C.; however, rapid weight loss and significant degradation of the PVOH occurs at temperatures greater than 250° C.

However, Aqua-Sol 1220 can be melt-processed at temperatures below 250° C. Table 2 shows the temperatures that have been evaluated on an injection molding machine for producing mold parts, such as casting cups for ophthalmic lens manufacturing. In this example, the processing temperatures that can be used for the injection molding of the casting cups are less than or equal to 250° C., which is the temperature of rapid thermal degradation of this particular modified PVOH. This demonstrates the use of a modified PVOH for casting cups via a typical thermoplastic processing method.

TABLE 2
Injection Molding Process Temperatures Evaluated
for Producing Casting Cups Composed of Modified
PVOH (Aqua-Sol 1220) for Ophthalmic lens Manufacturing

| Parameters | Unit | Setting |
|---|---|---|
| Minimum HR and/or Barrel Temperature | C | 160 |
| Maximum HR and/or Barrel Temperature | C | 250 |

Therefore, in some embodiments of the present invention directed to the use of a modified PVOH as the casting cup material in ophthalmic lens manufacturing, a processing temperature below the modified PVOH's thermal degradation temperature is desirable. In the example of Aqua-Sol 1220, the preferred processing temperature is from 160° C. to 240° C. The most preferred processing temperature is from 180° C. to 230° C.

In some additional embodiments, modified PVOH that exhibits a more hydrophilic surface than typical casting cup materials is preferred for applications, such as ophthalmic lens manufacturing. Table 3 compares the critical surface energy of a modified PVOH casting cup (Aqua-Sol 1220) to other typical casting cup materials.

TABLE 3
Comparison of Critical Surface Energy Between Modified
PVOH (Aqua-Sol 1220) and Typical Casting Cup Materials

| | Surface Energy (mN/m) | | Contact Angle (°) |
|---|---|---|---|
| Sample | Zisman | Owens-Wendt | Water |
| Zeonor 1060R | 27–28 | 28–29 | 96 |
| PP 9544 | 31–32 | 31–32 | 103 |
| PS with Zn-stearate | 31–32 | 32–33 | 90 |
| Aqua Sol 1220 (3 | 32.4 | 47.5 | 57 |
| liquids) (test1) | | | |
| Aqua Sol 1220 (test 2) | 40 | 48.2 | 50 |

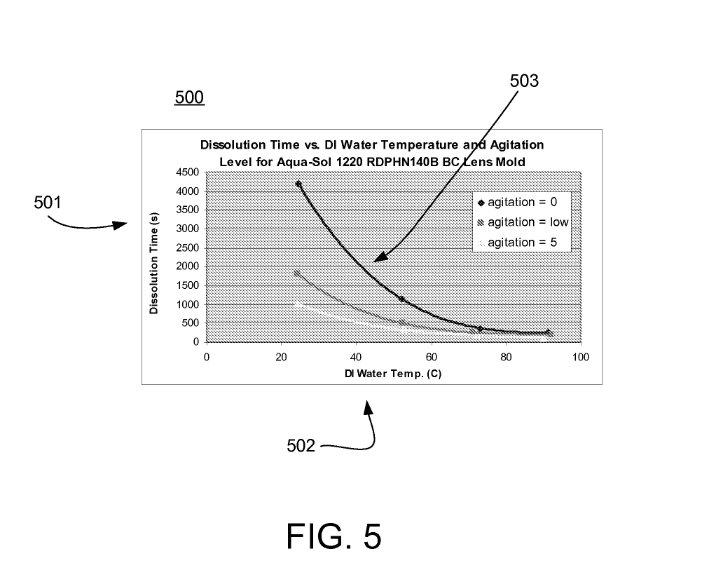

Referring now to FIG. 5, in some embodiments, a chart 500 indicates the dissolution time 501 of a mold part formed from water soluble material, such as a casting cup of modified PVOH, can be increased and/or decreased according to the process conditions under which the mold part is exposed to an aqueous solution. For example, increasing the temperature 502 and the agitation level 503 of the aqueous solution can increase the dissolution rate and decrease the dissolution time 501. FIG. 5 shows the relationship between dissolution time of a casting cup composed of modified PVOH (Aqua-Sol 1220) and water temperature and agitation level.

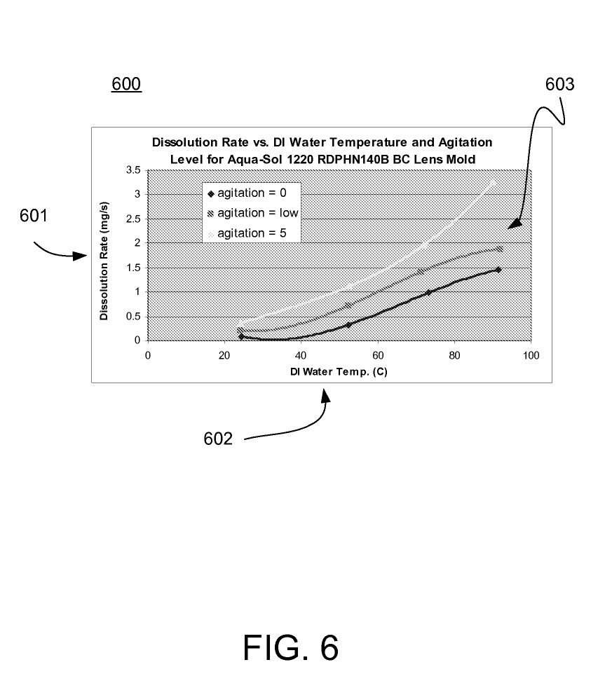

Referring now to FIG. 6, a chart 600 illustrates the relationship between the dissolution rate (g/s) 601 of an ophthalmic lens casting cup and water temperature 602 and agitation level 603, according to some embodiments of the present invention. Some preferred embodiments which use a modified PVOH as the casting cup material in ophthalmic lens processing, a water temperature of 0° C. to 100° C. allows for an acceptable dissolution rate. For embodiments which include an ophthalmic lens mold part, a preferred temperature range can include from 40° C. to 100° C., and a most preferred temperature can include from 65° C. to 95° C. In some embodiments, increasing the surface area of a mold part, such as a casting cup in contact with the water, using ultrasonic baths to agitate the water, and using additives in the water may also increase the dissolution rate.

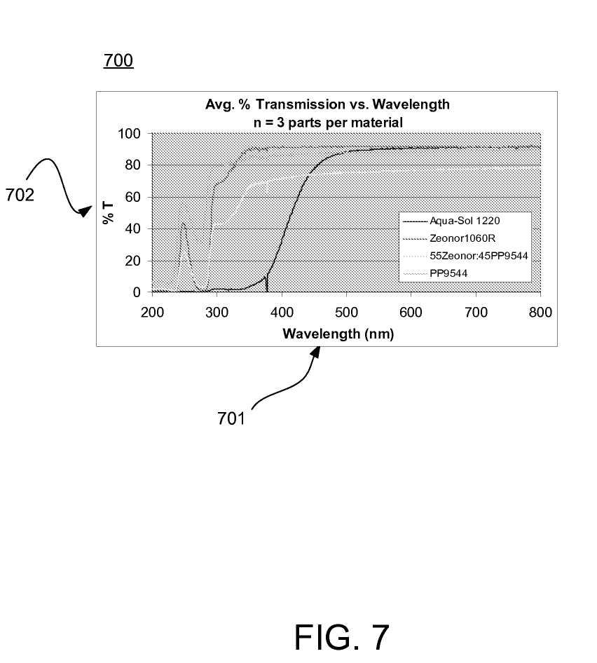

Referring now to FIG. 7, while the use of casting cups composed of 100% modified PVOH allows for complete solubility of the PVOH in water, in some embodiments, the use of mold parts composed of modified PVOH with other materials can also be desirable. Blends of modified PVOH with other materials can impart various desired attributes to the mold part, and thereby exhibit the water-soluble properties of PVOH along with the beneficial properties of the other material.

For example and without limitation, a 100% modified PVOH material, such as Aqua-Sol 1220, may exhibit a lower % light transmission 702 within the wavelengths 701 used to polymerize the ophthalmic lens monomer than other casting cup materials, as shown in FIG. 7. At 420 nm, the % transmission of Aqua-Sol is significantly lower than Zeonor1060R and Polypropylene (ExxonMobil PP9544). Therefore, the use of a blend of PVOH with another material with higher light transmittance may be desirable for achieving increased % transmission of the entire casting cup.

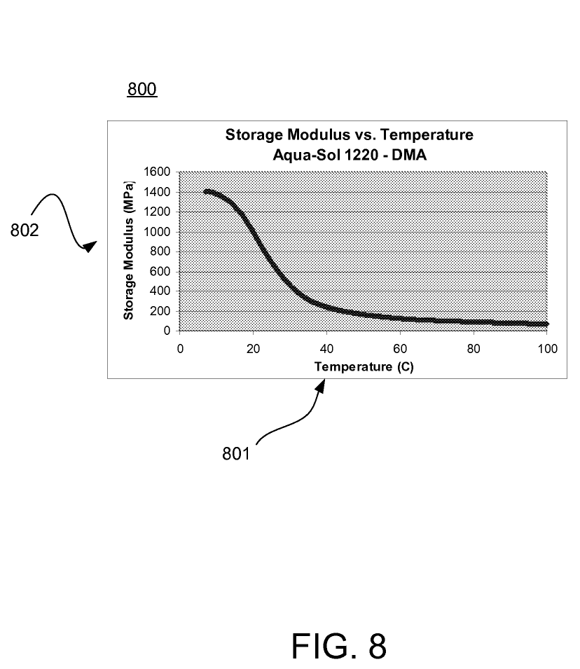

In addition, and referring now to FIG. 8, in some embodiments, a water soluble material, such as a 100% modified PVOH material, such as Aqua-Sol 1220, may exhibit a low storage modulus 802 within the temperature range 801 that the ophthalmic lens monomer is polymerized. FIG. 8 illustrates chart indicating the storage modulus of Aqua-Sol 1220 as a function of temperature 801. At room temperature, the modulus 802 is relatively low for ophthalmic lens manufacturing. At elevated temperatures 801, which may be used during the polymerization of the ophthalmic lens, the storage modulus 802 is significantly lower.

Therefore, the use of a blend of modified PVOH with other materials (i.e. fillers, reinforcements, other polymers, etc.) may be advantageous for those embodiments incorporating an increase in the storage modulus of a mold part.

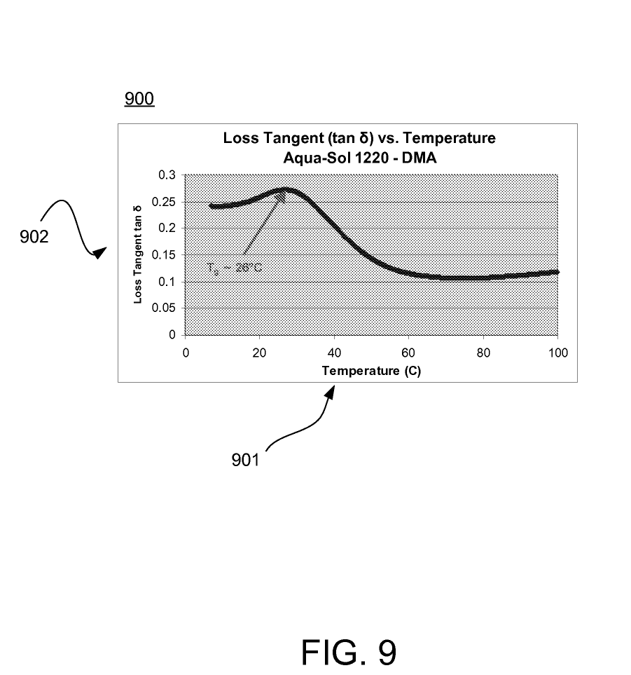

In another aspect, and referring now to FIG. 9, a chart 900 indicates that a mold part of 100% modified PVOH material, such as Aqua-Sol 1220, may exhibit a low glass transition temperature (T_{g}) 901, wherein a Loss Tangent (tan δ) 902 as a function of temperature for Aqua-Sol 1220, reveals that the T_{g} 901 is approximately 26° C. In some embodiments, a higher T_{g} 901 may be desired, which can be accomplished

Therefore, the use of a blend of modified PVOH with other materials is desirable for changing the T_{g} of the material of the entire casting cup

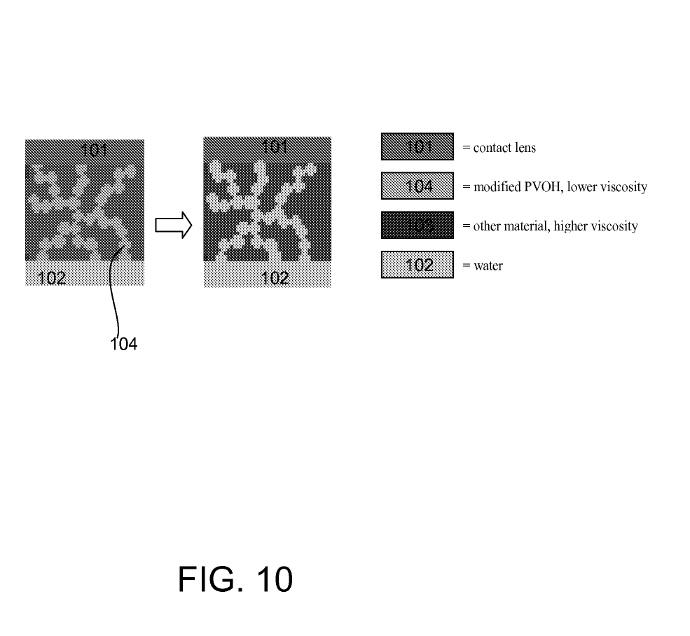

Referring now to FIG. 10, in some embodiments, a blend of modified water soluble and non-water soluble mold part materials can also be used to fashion a mold part. For example, in some embodiments, modified PVOH can be blended with an immiscible material to create a casting cup with PVOH “bridges” connecting both sides of the casting cup. Such embodiments allow an aqueous solution on the exterior of the casting cup to dissolve the PVOH bridge, creating a channel through which the aqueous solution can enter. The aqueous solution, which migrates to the interior of the casting cup, can then be useful to facilitate the release of the lens from the mold part.

Accordingly, the present invention provides mold parts, as well as methods and apparatus for forming the mold parts. According to the present invention, at least a portion of the mold part is formed from a water soluble material and a second material. While the present invention has been particularly described above and drawings, it will be understood by those skilled in the art that the foregoing ad other changes in form and details may be made therein without departing from the spirit and scope of the invention, which should be limited only by the scope of the appended claims.

What is claimed is:

1. A mold part for forming an ophthalmic lens, the mold part comprising;
a first material comprising a biodegradable polymer which decomposes when exposed to H₂O; and
a lens forming surface area in the shape of the ophthalmic lens which may be formed with the mold part.

2. The mold part of claim 1 wherein the first material comprises a modified polyvinyl alcohol with a melt processing temperature less than the thermal degradation temperature.

3. The mold part of claim 2 wherein the first material comprises polyvinyl alcohol compounded with plasticizers which reduce the melt processing temperature below the thermal degradation temperature.

4. The mold part of claim 2 wherein the thermal processing temperature is below about 250° C.

5. The mold part of claim 2 wherein the thermal processing temperature is between about 180° C. and 230° C.

6. The mold part of claim 1 wherein the first material comprises a dissolution rate which is relative to the temperature of the solution in which it is dissolved.

7. The mold part of claim 1 additionally comprising a surface layer comprising the first material and a second material; and
a core layer comprising the first material and the second material and essentially covered by the first layer, wherein, at any given cross section, the amount of the first material present in the surface layer is greater than the amount of the first material present in the core layer.

8. The mold part of claim 7 wherein the first material has a lower viscosity than the second material when subject to the injection molding process used to fashion the mold part.

9. The mold part of claim 7 wherein the first mold material comprises about 40% or more of the mold part.

10. The mold part of claim 1 wherein the first material and the second material comprise a polyolefin and the first material and the second material are not miscible on a molecular scale.

11. The mold part of claim 7 wherein:
the first material comprises a modified PVOH; and
the second material comprises a polyolefin and the second material is at least partially miscible on a molecular scale.

12. The mold part of claim 7 wherein the first material comprises a lower surface energy than the second material.

13. The mold part of claim 7 wherein the first material comprises a higher surface energy than the second material.

14. The mold part of claim 7 wherein the first material comprises a lower modulus than the second material.

15. The mold part of claim 7 wherein the first material comprises a lower percent of light transmission within the wavelengths used to polymerize a reaction mixture used to form the ophthalmic, lens than the percent of light transmission for the second material.

16. A mold part for forming an ophthalmic lens, the mold part comprising;
a first material comprising a polymer with a surface energy greater than about 40 mN/m; and
a lens forming surface area in the shape of the ophthalmic lens which may be formed with the mold part.

17. A method of forming a mold part for forming a biomedical device, the method comprising the steps of:
injection molding a first mold part comprising a first material comprising a biodegradable polymer which decomposes when exposed to H₂O;
combining the first mold part with a second mold part with a lens forming reaction mixture in between the first mold part and the second mold part;
curing the reaction mixture;
exposing the first material to an aqueous solution; and
dissolving at least a portion of the first material with the aqueous solution.

18. The method of claim 17 wherein the first material comprises a modified PVOH.

19. The method of claim 17 wherein the second mold part additionally comprises a second material which decomposes when exposed to H₂O and the method additionally comprises the step of exposing the second mold part to the aqueous solution and dissolving at least a portion of the second material.

20. The method of claim 19 wherein the first material and the second material comprise a modified PVOH.

21. The method of claim 17 additionally comprising the step of heating the aqueous solution.

22. The method of claim 17 additionally comprising the step of agitating the aqueous solution.

23. A method of forming an ophthalmic lens, the method comprising the steps of:
mixing a combined mold material comprising a first material and a second material, wherein the first material and the second material comprise a viscosity differential at the conditions present during injection molding of a first mold part and at least one of the first material and the second material is water soluble;
injection molding the combined mold material to form the first mold part wherein the first mold part comprises a first end proximate to the injection unit and a second end distal to the injection unit; and
forming a functional layer on the surface of the first mold part and a core layer beneath the functional layer; wherein at any given cross section, the amount of said first material in the functional layer is greater than the amount of said first material in the core layer;
injection molding a second mold part;
dosing an amount of a reaction mixture into a receiving area of one of the mold parts, wherein each mold part comprises a lens forming surface;
coupling the mold parts together to form the reaction mixture into a desired shape of the ophthalmic lens within a cavity formed between the first mold part and the second mold part;
curing the reaction mixture to fashion the ophthalmic lens;
exposing the first mold part and the second mold part to an aqueous solution; and
dissolving at least some of the water soluble material.

24. The method of claim 23 wherein at least one of the first mold part and the second mold part comprises an area capable of transmitting sufficient light energy to cure the reaction mixture.

25. The method of claim 23 wherein the injection molding is performed via a single injection unit.

26. The method of claim 23 wherein the first material and second material are combined with apparatus comprising two or more injection molding units used to injection mold the first mold part.
